(19) United States
(12) Patent Application Publication
(10) Pub. No.: US 2011/0008214 A1
(43) Pub. Date: Jan. 13, 2011

(54) PURIFICATION ASSEMBLY HAVING CATALYSTS FOR GASES AND COMBUSTION FUMES FROM SOLID FUEL HEATING APPARATUS

(75) Inventors: Frederic Haas, Lutterbach (FR); Fabien Ozil, Rimbach pres Masevaux (FR); Valerie Tschamber, Hombourg (FR); Gwenaelle Trouve, Brunstatt (FR)

Correspondence Address: DAVIS & BUJOLD, P.L.L.C., 112 PLEASANT STREET, CONCORD, NH, 03301, US

(73) Assignee: FONDIS, Thann (FR)

(21) Appl. No.: 12/933,553

(22) PCT Filed: Mar. 20, 2009
(86) PCT No.: PCT/FR2009/000301

§ 371 Date: Sep. 20, 2010

(30) Foreign Application Priority Data
Mar. 20, 2008 (FR) 08/01535

(51) Int. Cl. B01D 53/34

(52) U.S. Cl. 422/105; 422/168; 422/173; 422/174

(57) ABSTRACT

An assembly for purifying the gases and combustion fumes from a heating apparatus, particularly from a closed chimney furnace of the type using a catalyst device (7) in the gas and combustion fume exhaust duct (5). The assembly has an electrically powered rapid acting heater for raising the temperature, in and/or near the catalyst device (7), to initiate a catalytic reaction. A temperature-sensitive sensor or detector (12) is provided in the control circuit (11) of the heater. The assembly is of interest to builders of heating apparatuses using solid fuel, particularly wood.

This application is a National Stage completion of PCT/FR2009/000301 filed Mar. 20, 2009, which claims priority from French patent application Ser. No. 08/01535 filed Mar. 20, 2008.

### FIELD OF THE INVENTION

The invention relates to a catalytic assembly used to purify combustion gases and fumes from a solid fuel heating apparatus, particularly a high output wood heating apparatus, during all phases of operation.

This assembly contains a heated catalyst placed near or at the outlet at its upper portion and constituting the only outlet for combustion gas and fumes.

The catalyst is brought to a high temperature by an electrically charged rapid heating device for oxidizing, catalyzing or calcinizing gaseous pollutants and particles present in the gases and combustion fumes from a solid fuel heating apparatus, for example, a closed furnace in a wood burning heater. The catalyst constitutes the only possible passageway for combustion gases and fumes.

### BACKGROUND OF THE INVENTION

Catalysts already exist that are placed in the gas and combustion fume evacuation duct of a solid fuel heating apparatus, just at the furnace outlet.

Unfortunately, temperatures that are too low may result in these catalysts failing to activate during certain phases of operation, specifically during the transitory phases when the fire is being started up or extinguished. In actuality, with many pollutants, the catalytic reaction begins at around 400° C., a temperature difficult to attain at the furnace outlet, especially during transitory phases.

There is one known embodiment that uses post-combustion of unburned gases escaping from the furnace as a source of the complementary calorific energy required to raise the temperature of catalytic material in the catalyst placed in the exhaust conduit to the level necessary for engaging the catalytic reaction.

Unfortunately, there is a variable quantity of non-combusted material and the post-combustion process may not be not capable at any given moment of furnishing the supplemental calories necessary to start and sustain the process up to the permanent catalysis phase.

This rather random operation cannot guarantee that the gases and fumes evacuated through the flue will be constantly purified, nor is it possible to position a catalytic cell that would fill the entire space of the combustion gas and fume duct because contamination builds up quickly at lower burn rates.

### SUMMARY OF THE INVENTION

The goal of the present invention is to remove polluting gaseous effluents from these gases and fumes during all operating phases of the heating apparatus, even during transitory phases.

For this purpose a catalytic device is placed on the upper part of the vent or at the outlet of the combustion gas and fume evacuation duct of a solid fuel heating apparatus, particularly a wood-burning apparatus.

Whereas in the prior art, a diversion outlet was provided for combustion gases and fumes during the transitory fire startup and extinguishing phases for preventing rapid contamination, according to the present invention, the combustion gases and fumes pass through only this catalytic device; and it further comprises, close to and upstream of the direction in which the gases and fumes are evacuated, a rapid heating means to raise the catalyst to a high temperature, thus engaging the catalytic reaction during all phases of operation, even at lower temperatures that are more likely to contaminate the catalyst.

A temperature detector or sensor mounted in the control circuit stops the rapid heating means when the catalytic reaction is initiated.

In addition to its ability to purify polluting combustion gases and fumes, the invention offers several supplementary features.

The first is that the catalyst is permanently in effect, no matter how hot the fire is burning.

Next is the exceptional degree to which gases and fumes are purified, as they are reduced by a factor of six.

The simple design considerably enhances the life expectancy of the device.

Since the catalytic reaction is exothermal, there is a positive energy balance.

Additionally, there is no longer a diversion outlet for combustion gases and fumes during transitory operations.

Finally, the catalyst does not become contaminated and therefore it requires no maintenance regime.

### BRIEF DESCRIPTION OF THE DRAWINGS

Other characteristics and features of the invention will be apparent from the following description provided by way of example and accompanied by the drawings, in which:

FIG. 1 is a schematic vertical cross-section showing a rapid heating catalyst device mounted on the furnace outlet for heating by means of two high temperature resistors mounted at the source of the combustion gas and fume evacuation conduit of a wood burning heating apparatus;

FIG. 2 is an overhead view of a catalyst device with two resistors;

FIG. 3 is a view from below showing only the resistors;

FIG. 4 is a schematic vertical cross-section showing a rapid heating catalyst device mounted at the furnace outlet using a microwave heater also mounted at the source of the combustion gas and fume evacuation outlet of a wood burning heating apparatus;

FIG. 5 is a schematic vertical cross-section showing a rapid heating catalyst device mounted at the outlet of the vent and constituting its only outlet;

FIG. 6 is a schematic cross-section showing a rapid heating catalyst device mounted in the upper portion of the vent.

### DETAILED DESCRIPTION OF THE PREFERRED EMBODIMENTS

The present invention applies to a solid fuel heating apparatus such as a stove or a closed chimney furnace with an insert 1, having a furnace 2, a combustion chamber 3, a glass door 4, and an exhaust duct 5 for gas and combustion fumes. The duct 5 may be a continuation of a smoke box 6 with or without a heat exchanger or connect directly to a vent.

In this exhaust duct 5 at the outlet of the smoke box or the vent, the catalyst device 7 is placed, for example, at its source, in the form of a body 8 generally made of ceramic or metal, completely filling the interior of the exhaust duct and traversed completely and uniquely by the combustion gases and fumes.

The combustion gases and fumes have no outlet other than through catalyst device 7, even during the transitory phases of starting or extinguishing the fire.

When placed in the flue, the body 8 of catalyst device 7 assumes the same or approximately the same shape as the flue. Its interior space is formed of a plurality of parallel interior channels, for example, metal based channels such as platinum, palladium or the like, or metal oxides such as copper oxide or cerium.

All the combustion gases and fumes from the heating apparatus flow through this body 8, since it is placed in their path to the outside and it constitutes their only evacuation route.

According to the invention, a high temperature heater that uses electrical energy and preferably is a rapid heating device is placed near the catalyst device 7 and upstream of it.

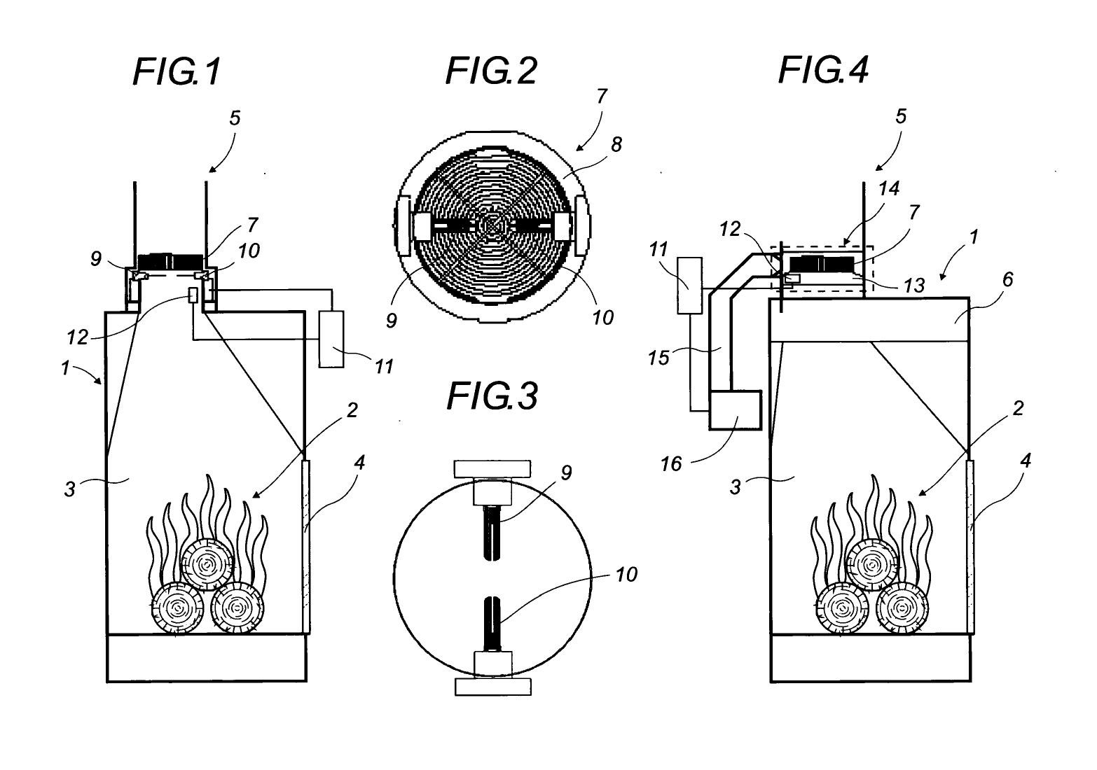

As shown in FIG. 1, there may be several resistors, for example two power resistors 9 and 10, respectively, operating at a high temperature, such as silicon carbide resistors. They may be the same type as those used to light gas heaters at a certain power level.

These high operating temperature resistors may be mounted in an element inserted in exhaust duct 5, preferably at the base and transverse to the trajectory of the gases and fumes, and near the intake surface of catalyst device 7. They are at least two in number, located opposite each other and disposed in a cross when there are four of them.

Heating and temperature elevation are quasi-instantaneous and the power climbs to approximately 600 watts by resistance.

The device operates in such a way that the resistor body becomes red hot quasi-instantaneously and the temperature in the area of the resistors quickly climbs to 1400-1500° C.

The resistors are placed along the trajectory of the combustion gases and fumes, at the immediate proximity of the surface of the catalyst device that faces the furnace, since the goal is to quickly heat primarily the body 8 and then the catalytic deposits on catalyst device 7.

These resistors reach high temperatures quickly. They diffuse heat by infrared radiation in the immediate vicinity of the body of the catalyst device. Thus the heat is transmitted directly to the catalytic material to shorten start-up time.

These resistors are supplied with electrical energy through a circuit 11 controlled by a temperature detector or sensor 12 placed upstream at the entry to the catalyst device. The sensor detects whether it is necessary to use the resistors for heating.

Therefore, the large temperature elevation at the catalyst entry will quickly initiate the catalytic reaction. Since the reaction is exothermic, it will cause a temperature increase at the outlet. The reaction will be self-maintaining so long as enough materials exist to oxidize and to maintain temperature conditions.

Heating from the resistors can then be stopped until it needs to be restarted. This becomes necessary when the fire dies down, for example, before reloading combustible fuel.

The rapid electrical heating means using electrical flow resistors and the catalyst may be replaced by any other electrically based rapid heating means.

For example, it is possible to use induction heating, microwave heating or other forms of rapid heating that use electrical energy.

Next, the example involving microwave heating will be described with reference to FIG. 4.

Body 8 is placed in an element 13 of the fume exhaust duct 5 that is not sensitive to microwaves, for example, a non-metal element.

Naturally the material used for this non-metal portion 11 must be resistant to the high temperatures attained by body 8 of catalyst device 7.

Around body 8 of the catalyst device, that is, around the element 13 that contains it, a reinforced surrounding 14 is created where the microwave energy will be conducted by one or more wave guides 15, originating from a microwave generator, for example, a magnetron 16.

Obviously protection must be in place in the area where microwave energy can escape as well as at the interior access area during operation.

In the same way, a heat sensor or detector 15 placed upstream of the catalyst determines whether it is necessary to use this additional heat, that is, it controls the starting and stopping of microwave generator 16.

The materials used in the area subjected to microwave energy must be non-calorifically active in the presence of microwaves so as to allow all the microwave energy to be used for heating the deposits of catalytic material located on the internal walls of the catalyst device.

It is possible to create a magnetic field using a coil, for example, which will heat the active deposits of catalytic material inside the catalyst body by induction, raising their temperature to the point that initiates the catalytic reaction.

The placement of the catalyst may be lower, at the outlet of the smoke box or the vent, or in their upper portion.

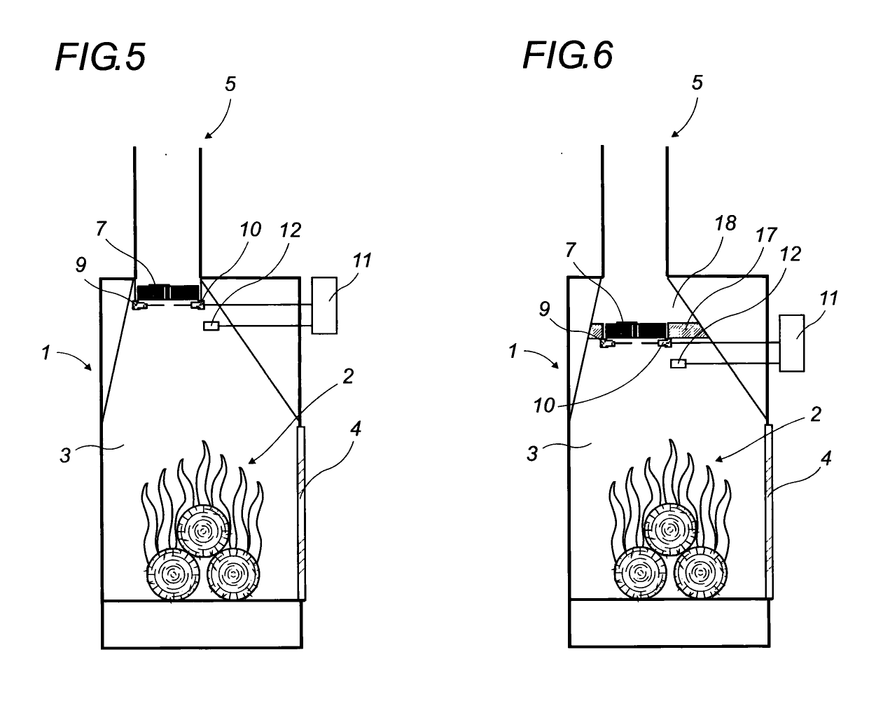

Examples of these arrangements are illustrated in FIGS. 5 and 6.

First, there is a catalyst device 7, the body 8 of which is placed directly at the outlet of the smoke box or of the vent inside the apparatus at the outlet connection (FIG. 5).

Body 8 of catalyst 7 may also be placed at the upper portion of the smoke box or the vent. In this case it is mounted in a blocking support 17 which supports the body of the catalyst and forms a barrier to the passage of combustion gases and fumes, forcing them to pass through the catalyst device (FIG. 6).

The blocking support 17 with its catalyst device 7 defines the top of the vent and an upper holding area 18 at its outlet.

In this latter variation the section of the catalytic device is not necessarily circular. On the contrary, it can vary and it may be square, rectangular, or some other shape.

Similarly the shape of blocking support 17 may serve as a deflector and it may vary in thickness.

Although the invention has been described using exemplary embodiments, it is not limited to these embodiments. On the contrary, all equivalent means and elements falling within its design do not diminish the scope of protection.

1-13. (canceled)

14. A catalytic assembly for purifying combustion gases and fumes in a solid fuel heating apparatus having a catalytic device (7) in a combustion gas and fume evacuation duct,
wherein the catalytic device (7) is positioned one of directly on or in an interior or an exterior vicinity of an outlet of either a smoke box or a vent,
the catalytic device (7) constitutes the only evacuation outlet for combustion gases and fumes,
a rapid temporary heating means, that uses electrical energy to substantially raise the temperature of the combustion gases and fumes, being at least one of upstream of and near the catalytic device (7), and
either a temperature-sensitive sensor or detector (12) is located upstream of the catalytic device (7), adjacent the catalytic device (7), and connected to a control circuit (11) for the heating means.

15. The purification assembly according to claim 14, wherein the catalytic device (7) is located in an upper portion of either the smoke box (6) or the vent in a blocking support (17), and the catalytic device (7) constitutes the only evacuation passageway for the combustion gases and fumes.

16. The purification assembly according to claim 14, wherein the heating means is placed just before a passageway for the combustion gases and fumes through the catalytic device (7) near a surface facing the furnace.

17. The purification assembly according to claim 14, wherein the heating means heats the support for the catalytic device (7).

18. The purification assembly according to claim 17, wherein the heating means uses infrared radiation.

19. The purification assembly according to claim 18, wherein the heating means is at least one high temperature electrical resistor (9, 10).

20. The purification assembly according to claim 19, wherein the at least one electrical resistor uses rapid strong infrared radiation.

21. The purification assembly according to claim 19, wherein the at least one electrical resistor (9, 10) is a silicon carbide resistor.

22. The purification assembly according to claim 14, wherein the heating means is an induction heating mechanism.

23. The purification assembly according to claim 14, wherein the heating means is hyperfrequency energy from a microwave generator (16).

24. The purification assembly according to claim 23, wherein the catalytic device (7) is placed in an element (13) that is insensitive to microwaves.

25. The purification assembly according to claim 23, wherein the assembly formed by the microwave generator (16) and the catalytic device (7) is protected, from at least one of external leaks and radiation, by a shield.

26. The purification assembly according to claim 14, wherein the temperature of the combustion gases and fumes is raised to approximately 1400° C.-1500° C.

27. A catalytic assembly for purifying combustion gases and fumes in a closed chimney furnace, the catalytic assembly comprising:
a catalytic device (7) being located within an exhaust passageway of the furnace (2), and the exhaust passageway being the sole outlet for exhausting the combustion gases and fumes to a chimney;
an electrical heating mechanism being located within the exhaust passageway either at or upstream of the catalytic device (7) for substantially raising the temperature of the combustion gases and fumes to enhance a catalytic reaction of the catalytic device (7);
a temperature sensor (12) being located within the exhaust passageway, upstream of the catalytic device (7), for determining a temperature of the combustion gases and fumes; and
a control circuit (11) communicating with the electrical heating mechanism and the temperature sensor (12) for controlling the heating mechanism depending on the temperature of the combustion gases and fumes.

28. The catalytic assembly according to claim 27, wherein the electrical heating mechanism is at least one high temperature electrical resistor (9, 10) located within the exhaust passageway, upstream of the catalytic device (7) and downstream of the temperature sensor (12).

29. The catalytic assembly according to claim 27, wherein the electrical heating mechanism is microwave assembly located within the exhaust passageway adjacent the catalytic device (7) and the temperature sensor (12).
